(19) United States
(12) Patent Application Publication
(10) Pub. No.: US 2022/0022158 A1
(43) Pub. Date: Jan. 20, 2022

(54) DOWNLINK POSITIONING REFERENCE SIGNAL DESIGN BASED ON DOWNLINK CHANNEL MEASUREMENTS

(71) Applicants: KEYVAN ZARIFI, OTTAWA (CA); NAVID TADAYON, KANATA (CA); ALIREZA BAYESTEH, OTTAWA (CA)

(72) Inventors: KEYVAN ZARIFI, OTTAWA (CA); NAVID TADAYON, KANATA (CA); ALIREZA BAYESTEH, OTTAWA (CA)

(73) Assignee: HUAWEI TECHNOLOGIES CO., LTD., SHENZHEN (CN)

(21) Appl. No.: 17/370,544

(22) Filed: Jul. 8, 2021

Related U.S. Application Data
(60) Provisional application No. 63/052,747, filed on Jul. 16, 2020.

(51) Int. Cl. H04W 64/00; H04W 24/10; H04W 8/24; H04L 5/00

(52) U.S. Cl. CPC H04W 64/006; H04L 5/0051; H04W 8/24; H04W 24/10

(57) ABSTRACT

Methods and devices utilizing downlink channel measurements for customization of downlink positioning reference signals (DL PRs) are provided. A serving base station (BS) for a targeted device and one or more non-serving BSs transmit respective downlink reference signals (DL RSs) to the targeted device. The targeted device reports respective downlink channel measurement information for each BS based on the received DL RSs. The BSs each transmit a respective DL PRS to the targeted device for downlink positioning measurement, wherein the respective DL PRS for each BS is configured based in part on the respective downlink channel measurement information reported by the targeted device for that BS. This allows the DL PRS for each BS to be configured taking into account downlink channel conditions between the BS and the targeted device, which can potentially improve positioning measurement accuracy by improving reception of the DL PRS at the targeted device.

### CROSS-REFERENCE TO RELATED APPLICATION

This application claims the benefit of U.S. Provisional Patent Application No. 63/052,747 entitled “DOWNLINK POSITIONING REFERENCE SIGNAL DESIGN BASED ON DOWNLINK CHANNEL MEASUREMENTS” filed Jul. 16, 2020, the entire contents of which is incorporated herein by reference.

### TECHNICAL FIELD

The present disclosure relates to wireless communication generally and, in particular embodiments, to methods and apparatuses for downlink positioning.

### BACKGROUND

In wireless communications networks, positioning is the process of determining the geographical location of a device, such as a mobile device (e.g., smartphone, laptop, tablet or personal digital assistant (PDA), etc.) or navigation/tracking equipment. A device for which a position is to be determined may be referred to as a target device. Once the coordinates of a target device have been established, the coordinates may be mapped to a location (e.g., a road, a building address, etc.), and then reported to a requesting service or device. The mapping functionality and the delivery of location information may be referred to as location services (LCS), which various other services may depend upon. Services that utilize location data may be referred to as location-based services (LBSs). LBSs can be used to provide location aware applications for a user of a device (e.g., to deliver localized weather forecasts, location-specific targeted advertising, navigation applications, emergency services, etc.), optimize network performance and/or to enhance automated services (e.g., network self-learning, self-optimization, etc.).

An increasing number of applications that rely on accurate and timely wireless-device positioning are being developed, and therefore there is an increasing demand for more accurate and reliable positioning. Downlink-based positioning solutions are based on the transmission of downlink (DL) positioning reference signals (PRSs) from multiple network nodes in a radio access network (RAN), and the reporting by a target device of measurements based on the received DL PRSs at the target device. The measurements performed by the target device might include DL Reference Signal Time Difference (DL RSTD), Reception-Transmission (Rx-Tx) time difference, and/or DL PRS Reference Signal Received Power (RSRP) measurements, for example.

However, DL-based positioning in a wireless communication network is challenging due to several factors, such as the mobility of devices and the dynamic nature of the environment and wireless signals.

Therefore, it would be desirable to provide methods and apparatuses for improved DL-based positioning in a wireless communication network.

### SUMMARY

As noted earlier, downlink-based positioning is generally based on the transmission of DL PRSs from multiple network nodes, and the reporting of measurements based on the received DL PRSs at the target device. In some wireless networks, a target device is provided with information regarding the DL PRSs that it can expect to receive, which may assist the target device in receiving the DL PRSs. For example, a target device may be provided with DL PRS resource configuration information (assistance data) which indicates configuration parameters/fields for the DL PRSs that will be transmitted for downlink positioning measurements by the target device. The DL PRS resource assistance data may include information indicating the time-frequency resources on which the DL PRSs will be transmitted, for example.

For example, in a wireless networks operating in accordance with the 3rd Generation Partnership Project (3GPP) Release 16 New Radio (NR) specification, a user equipment (UE) that is a target device may receive DL PRS resources assistance data either using LTE Positioning Protocol (LPP) Assistance Data or as a part of Positioning System Information Block (posSIB). Each DL PRS resource assistance data may optionally include an indication of a Quasi Co-Location Type D (QCL-D) and/or Quasi Co-Location Type C (QCL-C) to help the target device receive the corresponding DL PRS resource. In particular, QCL-D is used to adjust the target device's receive beamformer and QCL-C is primarily used to limit the search window for receiving DL PRS. For example, each DL PRS resource assistance data may optionally include an indication of a QCL-D and/or QCL-C with a Synchronization Signal-Physical broadcast channel block (SS-PBCH block, or SSB) or a QCL-D with another DL PRS resource.

In general, multiple DL PRS resources can belong to the same DL PRS resource set and each TRP can potentially transmit multiple DL PRS resource sets in different positioning frequency layers.

In current DL-based positioning solutions, a target device may signal some general capability regarding DL PRS measurements such as the supported maximum bandwidth of DL PRS, maximum number of positioning frequency layers, maximum total and per positioning frequency layer PRS resources, and/or maximum number of TRPs across positioning frequency layers. However, there is currently no signaling mechanism for a UE, or other target device, to implicitly or explicitly indicate a preferred configuration for the DL PRS. Moreover, the optionally indicated QCL in the DL PRS resource configuration is only helpful if the QCL source is already detected by the target device.

In existing DL-based positioning solution, the transmitted DL PRS from TRPs are not specifically designed based on the DL channel between the TRP and the target device. On the contrary, in existing DL-based positioning solutions, the DL PRS transmitted from TRPs are generic and designed to be receivable by as many target devices as possible without consideration of the DL channel conditions of an individual target device.

The present disclosure provides methods and apparatuses that may be used to implement new downlink positioning reference signals based on downlink channel measurements.

For example, embodiments of the present disclosure include new positioning reference signal designs that go beyond generic downlink positioning reference signals to provide customized downlink positioning reference signals that, for each target device, are configured based in part on downlink channel measurements reported by the target device.

A first broad aspect of the present disclosure provides a method for positioning in a wireless communication network in which a downlink (DL) positioning reference signal (PRS) that is transmitted to a target device for a positioning measurement is configured based at least in part on a DL channel measurement reported by the target device. For example, the target device may receive a DL reference signal (RS) from a base station (BS) in the wireless communication network and transmit DL channel measurement information regarding one or more DL channel measurements obtained by the target device based on the received DL RS. The target device may then receive from the BS a DL PRS configured based at least in part on the DL channel measurement information. The target device may in turn transmit positioning measurement information regarding one or more location measurements obtained by the target device based on the received DL PRS. Because the network knows something about the DL channel between the BS and the target device based on the DL channel measurement information reported by the target device, the network may configure the DL PRS taking into account any detrimental effects of the DL channel, which potentially results in a better quality of DL PRS reception at the UE and a more accurate positioning measurement.

In some embodiments, the target device receives a respective DL RS from each of a plurality of BSs in the wireless communication network. The plurality of BSs may include a serving BS and one or more non-serving BS for the target device. In such embodiments, the DL channel measurement information that is transmitted by the target device may include, for each BS of the plurality of BSs, respective DL channel measurement information regarding one or more DL channel measurements based on the respective DL RS received from the corresponding BS. The target device may then receive, from each of the plurality of BSs, a respective DL PRS, each respective DL PRS being configured based in part on the respective DL channel measurement information for the corresponding BS. By having knowledge about the DL channel between each of the BSs and the target device based on the DL channel measurement information reported by the target device, the network may configure the DL PRS for each BS to potentially improve the quality of DL PRS reception at the UE and, thus, accuracy of the positioning measurement.

In some embodiments, the target device may receive DL RS assistance data for use in assisting the target device to receive the DL RS. For example, the DL RS assistance data is received by the target device via a Long Term Evolution Positioning Protocol (LPP) message from a Location Management Function (LMF) in the wireless communication network.

In some embodiments, the target device receives a request for DL channel measurement information. The request may be received from a LMF in the wireless communication network, for example. In such embodiments, after receiving the request for DL channel measurement information, the target device may, in accordance with the request, receive the DL RS, perform the one or more DL channel measurements, and transmit the DL channel measurement information in response to the request. In some cases, the request for DL channel measurement information may be received by the target device via a Long Term Evolution Positioning Protocol (LPP) message from the LMF, and the DL channel measurement information may be transmitted to the LMF via a LPP message from the target device.

In some embodiments, the target device transmits DL RS capability information regarding DL RS processing capability and/or related DL channel measurement capability for the target device. The DL RS capability information may be used by the network to configure the DL RSs for the target device so that the configured DL RSs take into account the capabilities of the target device.

In some embodiments, the target device receives DL RS configuration information from a serving BS, e.g., via a radio resource control (RRC) message, for use in assisting the target device to receive respective DL RSs from a plurality of BSs that includes the serving BS and one or more non-serving BSs.

In some embodiments, the target device receives DL measurement configuration information from a serving BS, e.g., via a RRC message. In such embodiments, the target device, after receiving the DL measurement configuration information, may, in accordance with the request: receive the respective DL RS from each BS; perform, for each BS of the plurality of BSs, the one or more DL channel measurements based on the respective DL RS received from the corresponding BS; and transmit the DL channel measurement information that includes, for each BS of the plurality of BSs, the respective DL channel measurement information based on the one or more DL channel measurements for the corresponding BS. For example, in some embodiments, the target device may transmit the DL channel measurement information to the serving base station.

A second broad aspect of the present disclosure provides an apparatus for downlink positioning of a target device in a wireless communication network. For example, the apparatus may include at least one processor and a computer readable storage medium operatively coupled to the at least one processor. The computer readable storage medium may store programming for execution by the at least one processor, the programming comprising instructions for implementing the method according to the first broad aspect of the present disclosure.

A third broad aspect of the present disclosure provides a method for downlink positioning in a wireless communication network in which a BS transmits a DL RS to a target device in the wireless communication network, and later transmits a DL PRS to the target device that is configured based in part on DL channel measurement information reported by the target device based on the received DL RS at the target device.

In some embodiments, the BS is a non-serving BS for the target device. In other embodiments, the BS is a serving BS for the target device.

In some embodiments, the BS transmits DL RS capability information to a LMF in the wireless communication network. For example, the DL RS capability information may indicate DL RS configurations the BS is capable of transmitting for DL channel measurement.

In some embodiments, before transmitting the DL RS to the target device, the BS receives a DL RS information request from the LMF. The DL RS information request may be a request for the BS to provide DL RS configuration information regarding configuration of the DL RS that will be transmitted to the target device for DL channel measurement.

In some embodiments, the DL RS information request that is received from the LMF may include information regarding at least a partial suggested configuration for the DL RS that will be transmitted to the target device. For example, the LMF may suggest one or more of the configuration fields/parameters that characterize a DL RS. The LMF may base the suggested configuration fields/parameters at least in part on knowledge of the target device that the BS may not have, and thus may allow the LMF to make suggestions that are more optimized for the particular target device.

In some embodiments, the BS transmits a DL RS information response to the LMF. For example, the DL RS information response might contain the requested DL RS configuration information for the DL RS that will be transmitted to the target device for DL channel measurement. By providing the requested DL RS configuration information to the LMF, the LMF may then be able to transmit DL RS assistance information to the target device in order to advise the target device of the DL RS configuration the target device can expect to receive from the BS. This may assist the target device in receiving the configured DL RS.

In some embodiments, the DL RS transmitted by the BS to the target device is configured in accordance with the DL RS configuration information transmitted to the LMF in the DL RS information response.

In some embodiments, before transmitting the DL RS to the target device, the BS may receive a DL RS activation request from the LMF to transmit the DL RS to the target device for DL channel measurement. In some cases, the DL RS activation request may include information regarding at least a partial suggested configuration for the DL RS that will be transmitted to the target device.

In some embodiments, the BS is a non-serving base station for the target device, and the non-serving base station may transmit, to a serving base station for the target device, DL RS configuration information for the DL RS that the non-serving base station is configured to transmit to the target device for DL channel measurement.

In some embodiments, the BS is a serving base station for the target device, and the serving base station receives, from each of one or more non-serving base stations for the target device, respective DL RS configuration information for the respective DL RS that each non-serving base station is configured to transmit to the target device for DL channel measurement. In such embodiments, before transmitting the DL RS to the target device, the serving base station may transmit, to the target device, DL RS configuration information for the DL RS the serving base station is configured to transmit to the target device, and respective DL RS configuration information for the respective DL RS each of the one or more non-serving base stations is configured to transmit to the target device.

In some embodiments, before transmitting the DL RS to the target device, the serving base station may transmit, to the target device, DL measurement configuration information to configure the target device to report DL channel measurement information for the serving base station and the one or more non-serving base stations based on the DL RS transmitted by the serving base station and the respective DL RS transmitted by each of the one or more non-serving base stations.

In some embodiments, the serving base station may receive, from the target device, a report of the DL channel measurement information for the serving base station and the one or more non-serving base stations.

In some embodiments, before transmitting the DL PRS to the target device, the serving base station may transmit, to a LMF in the wireless communication network, DL PRS configuration information for the DL PRS the serving base station is configured to transmit to the target device based in part on the DL channel measurement information reported by the target device for the serving base station.

In some embodiments, the serving base station may transmit, to each of the one or more non-serving base stations, the respective DL channel measurement information reported by the target device for the non-serving base station.

In some embodiments, before transmitting the DL PRS to the target device, the non-serving base station transmits, to a LMF in the wireless communication network, DL PRS configuration information for the DL PRS the non-serving base station is configured to transmit to the target device based in part on the DL channel measurement information reported by the target device for the non-serving base station.

A fourth broad aspect of the present disclosure provides an apparatus for downlink positioning of a target device in a wireless communication network. For example, the apparatus may include at least one processor and a computer readable storage medium operatively coupled to the at least one processor. The computer readable storage medium may store programming for execution by the at least one processor, the programming comprising instructions for implementing the method according to the third broad aspect of the present disclosure.

### BRIEF DESCRIPTION OF THE DRAWINGS

Reference will now be made, by way of example, to the accompanying drawings which show example embodiments of the present application, and in which:

FIG. 1 is a schematic diagram of an example communication system suitable for implementing examples described herein;

FIGS. 2 and 3 are block diagrams illustrating example devices that may implement the methods and teachings according to this disclosure;

FIG. 4 is a block diagram of an example computing system that may implement the methods and teachings according to this disclosure;

FIG. 5 illustrates an example of an over the air information exchange procedure for channel state information assisted (CSI-assisted) downlink-based positioning, in accordance with an embodiment of this disclosure; and

FIG. 6 illustrates another example of an over the air information exchange procedure for CSI-assisted downlink-based positioning, in accordance with an embodiment of this disclosure.

Similar reference numerals may have been used in different figures to denote similar components.

### DESCRIPTION OF EXAMPLE EMBODIMENTS

To assist in understanding the present disclosure, an example wireless communication system is described below.

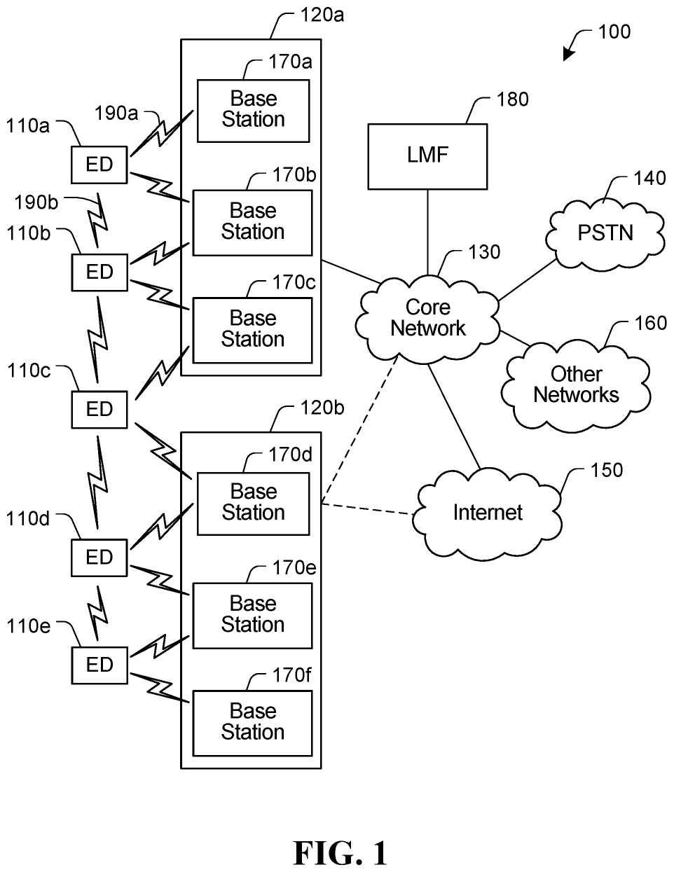

FIG. 1 illustrates an example wireless communication system 100 (also referred to as wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, narrowcast, user device to user device, etc.) among entities of the system 100. The wireless system 100 may operate by sharing resources such as bandwidth. The wireless system 100 may be suitable for wireless communications using 5G technology and/or later generation wireless technology (e.g., 6G or later). In some examples, the wireless system 100 may also accommodate some legacy wireless technology (e.g., 3G or 4G wireless technology).

In the example shown, the wireless system 100 includes electronic devices (ED) 110a-110e (generically referred to as ED 110), radio access networks (RANs) 120a-120b (generically referred to as RAN 120), a location management function (LMF) server 180, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The EDs 110 are configured to operate, communicate, or both, in the wireless system 100. For example, the EDs 110 may be configured to transmit, receive, or both via wireless or wired communication channels. Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, or a consumer electronics device, among other possibilities. Future generation EDs 110 may be referred to using other terms.

In FIG. 1, the RANs 120 include base stations (BSs) 170a-170f (generically referred to as BS 170), respectively. Each BS 170 is configured to wirelessly interface with one or more of the EDs 110 to enable access to any other BS 170, the LMF 180, the core network 130, the PSTN 140, the internet 150, and/or the other networks 160. For example, the BS 170s may include (or be) one or more of several well-known devices, such as a base transceiver station (BTS), a radio base station, a Node-B (NodeB), an evolved NodeB (eNodeB), a Home eNodeB, a gNodeB (sometimes called a next-generation Node B), a transmission point (TP), a transmit and receive point (TRP), a site controller, an access point (AP), or a wireless router, among other possibilities. Future generation BSs 170 may be referred to using other terms. Any ED 110 may be alternatively or additionally configured to interface, access, or communicate with any other BS 170, the LMF 180, the internet 150, the core network 130, the PSTN 140, the other networks 160, or any combination of the preceding. The wireless system 100 may include RANs, such as RAN 120b, wherein the corresponding BSs 170d-170f access the core network 130 via the internet 150, as shown.

The EDs 110 and BSs 170 are examples of communication equipment that can be configured to implement some or all of the functionality and/or embodiments described herein. In the embodiment shown in FIG. 1, the BSs 170a-170c forms part of the RAN 120a, which may include other BSs, base station controller(s) (BSC), radio network controller(s) (RNC), relay nodes, elements, and/or devices. Any BS 170 may be a single element, as shown, or multiple elements, distributed in the corresponding RAN, or otherwise. Also, the BSs 170d-170f form part of the RAN 120b, which may include other BSs, elements, and/or devices. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. In some embodiments, multiple transceivers could be used for each cell, for example using multiple-input multiple-output (MIMO) technology. The number of RANs 120 shown is exemplary only. Any number of RANs may be contemplated when devising the wireless system 100.

The BSs 170 communicate with one or more of the EDs 110 over one or more air interfaces 190a using wireless communication links (e.g. radio frequency (RF), microwave, infrared (IR), etc.). The EDs 110 may also communicate directly with one another via one or more sidelink air interfaces 190b. The interfaces 190a and 190b may be generally referred to as air interfaces 190. BS-ED communications over interfaces 190a and ED-ED communications over interfaces 190b may use similar communication technology. The air interfaces 190 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190. The air interfaces 190 may utilize other higher dimension signal spaces, which may involve a combination of orthogonal and/or non-orthogonal dimensions.

The RANs 120 are in communication with the core network 130 to provide the EDs 110 with various services such as voice, data, and other services. The RANs 120 and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120 or EDs 110 or both, and (ii) other networks (such as the PSTN 140, the internet 150, and the other networks 160). In addition, some or all of the EDs 110 may include functionality for communicating with different wireless networks over different wireless links using different wireless technologies and/or protocols. Instead of wireless communication (or in addition thereto), the EDs 110 may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110 may be multimode devices capable of operation according to multiple radio access technologies, and incorporate multiple transceivers necessary to support such.

LMF 180 is a physical or logical element that manages positioning for target devices, such as EDs 110. For example, LMF 180 may collect measurements and/or other location information, assist the target devices in calculating measurements, and estimate the target device location, as will be discussed in further detail herein. The wireless system 100 may include one or more LMF clients (not shown) that interact with the LMF 180 to obtain location information for targets devices.

An LMF client may be implemented as a software and/or hardware element and may reside in a target device, for example. An LMF client may send a request to the LMF 180 to obtain positioning information. For example, a positioning request may originate from the target device or may originate from another device within the network, which could potentially be another user device (e.g., another ED 110) or a network node (e.g., BS 170). For example, LTE operates two positioning protocols via the radio network, namely LTE Positioning Protocol (LPP) and LPP Annex (LPPa). LPP is a point-to-point protocol for communication between an LMF serve (e.g., LMF 180) and a target device (e.g., ED 110), and is used to position the target device. In LTE, LPPa is a communication protocol between an eNodeB (e.g., BS 170) and an LMF (e.g., LMF 180) for control-plane positioning. In some cases, LPPa communication may be used to assist user-plane positioning by querying eNodeBs for information and measurements. Although the LMF 180 is shown as being a separate element that is in communication with the core network 130 in FIG. 1, in some implementations the LMF 180 may be implemented within the core network 130, e.g., as an Evolved Serving Mobile Location Center (E-SMLC) or a Secure User Plane Location Platform (SLP).

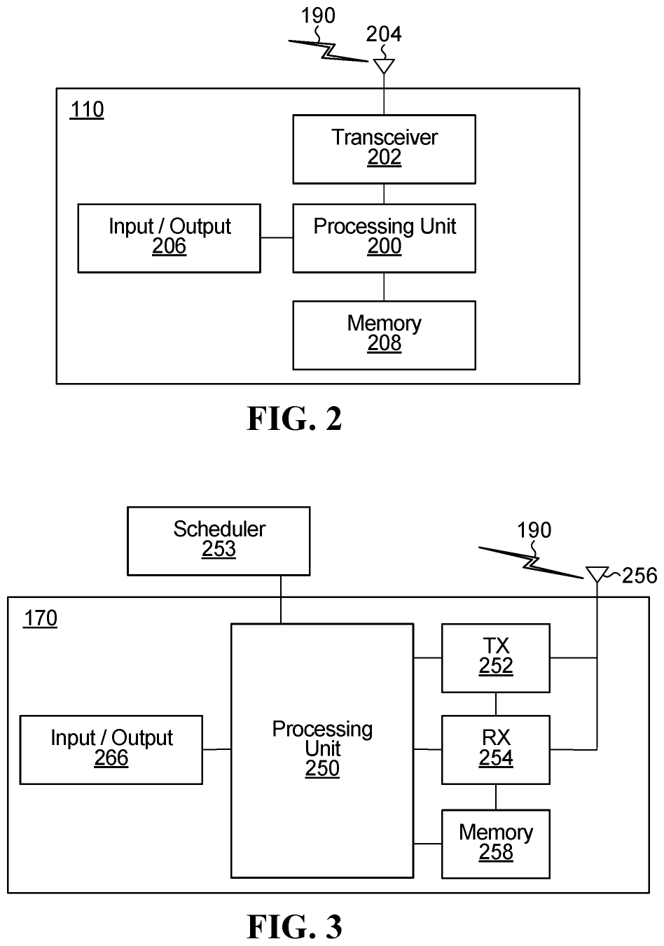

FIGS. 2 and 3 illustrate example devices that may implement the methods and teachings according to this disclosure. In particular, FIG. 2 illustrates an example ED 110, and FIG. 3 illustrates an example base station 170. These components could be used in the communication system 100 or in any other suitable system.

As shown in FIG. 2, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail elsewhere herein. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150 in FIG. 1). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3, the base station 170 includes at least one processing unit 1350, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail herein. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110 in FIG. 2. The memory 258 stores instructions and data used, generated, or collected by the base station 170. For example, the memory 258 could store software instructions or modules configured to implement some or all of the functionality and/or embodiments described herein and that are executed by the processing unit(s) 250.

Each input/output device 266 permits interaction with a user or other devices in the network. Each input/output device 266 includes any suitable structure for providing information to or receiving/providing information from a user, including network interface communications.

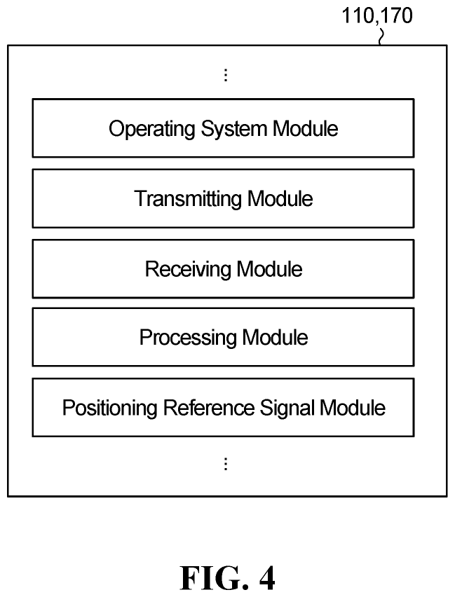

It should be appreciated that one or more steps of the embodiment methods provided herein may be performed by corresponding units or modules, according to FIG. 4. For example, a signal may be transmitted by a transmitting unit or a transmitting module. A signal may be received by a receiving unit or a receiving module. A signal may be processed by a processing unit or a processing module. Other steps, such as those relating to the downlink (DL)-based positioning solutions described herein, may be performed by a positioning reference signal module. The respective units/modules may be implemented using hardware, one or more components or devices that execute software, or a combination thereof. For instance, one or more of the units/modules may be an integrated circuit, such as field programmable gate arrays (FPGAs) or application-specific integrated circuits (ASICs). It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs such as 110 and base stations such as 170 are known to those of skill in the art. As such, these details are omitted here.

Referring back to FIG. 1, different pairs of communicating devices (i.e., a transmission sending device and a transmission receiving device), such as ED 110a communicating with BS 170a or ED 110e communicating with BS 170f, may be experiencing different channel conditions and/or may have different communication/processing capabilities and/or requirements.

However, in existing DL-based positioning solutions, because there is no signaling mechanism for a target device to implicitly or explicitly indicate a preferred configuration for the DL PRS, the DL PRSs are configured and transmitted without taking into account the DL channels from the network nodes such as BSs 170 to the target device such as EDs 110. As a result, the target device may not be able to carry out the requested measurements for positioning with enough accuracy. For instance, due to the use of a DL PRS precoder that is not based on feedback from the target device, positioning measurements such as a DL Reference Signal Time Difference (RSTD) measurement on the received DL PRS may be mistakenly carried out on a non-line of sight (NLOS) path because the line of sight (LOS) path of the received DL PRS may have been buried under the noise level of the target device's downlink channel.

The present disclosure provides DL-based positioning solutions in which each serving or neighboring (non-serving) BS for a target device transmits DL PRS resources that are configured based on the DL channel condition of the target device. A serving BS may be defined as the BS that a target device is connected to and that provides the target device with data and control signaling. In contrast, there may be no direct data or control signaling between the neighboring (non-serving) BSs and the target device. In general, a target device, such as a UE, can perform measurements on some DL reference signals (RSs) transmitted from non-serving BSs, and the non-serving BSs may be able to receive and measure some uplink (UL) RSs from the UE. RS configuration information may be exchanged in order to assist/configure the target device and/or the neighboring BSs to transmit such transmissions (DL RS/UL RS) at the transmitting device (BS/target device) and/or to make corresponding measurements at the receiving device (target device/BS). However, RS configuration information may not be directly communicated between the neighboring BSs and the target device. Instead, these configurations may be indirectly communicated between a target device and neighboring BSs through a third network node such as the serving BS or some other network function such as a LM F.

In general, the DL-based positioning solutions disclosed herein for determining the positioning of a target device in a wireless communication network are generally based on the following major elements/steps:
1. Multiple network nodes, which may include the serving BS for the target device and one or more non-serving BSs, each transmits DL RS resources to the target device.
2. The target device carries out DL channel measurements based on DL RS resources received from each network node (e.g., the serving BS and the neighboring/non-serving BS(s)) and reports the measurements back to the network (e.g., LMF or the serving BS). In most cases, the DL channel measurements carried out by the target device are based on received DL RS from a serving BS for the target device and one or more neighboring/non-serving BSs but the report of the DL channel measurements may be transmitted by the target device to the serving BS or another network node such as an LMF, rather than being sent directly to the non-serving BS(s). In general, there is no direct report of DL channel measurements based on the DL RS from the target device to the neighboring/non-serving BS(s).
3. The network configures DL PRSs to be transmitted to the target device from the network nodes based at least in part on the DL channel measurement reports for the network nodes.
4. The network nodes transmit configured DL PRS resources to the target device for positioning measurements.
5. The target device reports positioning measurements based on DL PRS resources received from the network nodes back to the network.

The foregoing elements/steps enable the network to configure a DL PRS for each network node (e.g., each serving BS and one more non-serving BSs) to transmit to the target device based on the DL channel condition between the network node and the target device. As a result, the positioning measurements carried out by the target device may be more accurate which, in turns, may result in a more accurate estimation of the location of the target device. As a simple example, if the DL RS channel measurement is available at the network side, it can be used to determine a precoder for the DL PRS to “pre-compensate” for the DL channel imperfections. Therefore, when the precoded DL PRS is received at the UE side, it may be received with a better quality (higher SNR, RSRP, or less effective channel dispersion). Such a better quality of the received DL PRS directly translates into a more accurate positioning measurement. For instance, when measuring DL PRS RSTD, there may be a larger correlation peak and less likeliness that the correlation peak will be buried under the noise floor or be mistaken or corrupted by the neighboring aliased peaks. Therefore, the RSTD measurement may be more accurate.

How the DL channel measurements are used to configure DL PRS is, in general, an implementation-specific issue. In general, the configuration may be based on compensating for detrimental effects of a BS-UE DL channel that each DL PRS has to go through before it reaches the target device. In particular, because the network knows something about the BS-UE DL channel based on the DL channel measurement information reported by the target device, the network may configure the DL PRS for each BS taking into account any detrimental effects of the BS-UE DL channel between the BS and the target device. This potentially results in a better quality of DL PRS reception at the UE and a more accurate positioning measurement.

Examples of DL channel measurements based on DL RS received from a serving or a non-serving BS in step 2 above may include, but are not limited to, one or more of the following:
Channel state information (CSI) measurement including channel quality indicator (CQI), precoding matrix indicator (PMI), CSI-RS resource indicator (CRI), rank indicator (RI), layer indicator (LI);
Reference signal received power (RSRP) (including layer 1 RSRP (L1-RSRP) or layer 3 RSRP (L3-RSRP)), reference signal received quality (RSRQ), received signal strength indicator (RSSI), signal-to-interference-plus-noise ratio (SINR);
(quantized) estimated DL multiple input multiple output (MIMO) channel;
DL MIMO channel characteristics such as the N largest singular values and/or associated singular vectors where N is a configurable number
DL reference signal time of arrival
Downlink angle of arrival (DL-AoA)
Downlink angle of departure (DL-AoD)
Carrier-phase measurement
Code-phase measurement
Doppler measurement
Accumulated Doppler Range (ADR) measurement

Any of the above measurements can be accompanied with one or multiple measurement quality metrics. For example, a measurement quality value may be included that provides a best estimate of the uncertainty of the measurement. In some embodiments, a measurement quality resolution may also be included that provides the resolution levels used in the value field.

In some embodiments, non-limiting examples of DL RSs that a target device may perform DL channel measurements on might include, but are not limited to, one or more of the following: a configured Synchronization Signal-Physical broadcast channel blocks (SS-PBCH block), a channel state information reference signal (CSI-RS), a tracking reference signal (TRS), or a positioning reference signal (PRS) from a serving or non-serving BS.

DL channel measurements such as those discussed above may be reported by the target device in different ways in different embodiments. Examples of ways in which the DL channel measurements may be reported include, but are not limited to one of the following:
One measurement reported for each serving or non-serving BS from which the target device receives DL RS. For example, for any of the measurement types discussed above (e.g., CQI, RSRP, DL-AoD, ADR, etc.) only one measurement may be reported per BS. In such embodiments, the target device may perform measurement on one DL RS resource (set) (e.g., CSI-RS resource (set)), or multiple DL RS resources (sets) of the same BS on one or multiple frequencies or frequency layers and then provide only one report based on all measurements for that particular BS.
One measurement is reported for each DL resource or resource set of each BS from which the target device receives DL RS. For example, for any of the measurement types discussed above (e.g., CQI, RSRP, DL-AoD, ADR, etc.) one measurement is reported for each DL RS resource (set) received from each BS. If a BS transmits multiple DL RS resource (sets), then multiple measurements are reported for that BS, each of which corresponds to one DL RS resource (set).
One measurement is reported for each receiver branch or one report across multiple receiver branches. For example, for any of the measurement types discussed above (e.g., CQI, RSRP, DL-AoD, ADR, etc.) when a target device has two receiver branches, one measurement may be reported for branch one and another measurement may be reported for branch two.
One measurement is reported for each receiver antenna panel or one report across multiple receiver antenna panels. For example, for any of the measurement types discussed above (e.g., CQI, RSRP, DL-AoD, ADR, etc.) when a target device has two receiver antenna panels, one measurement may be reported for antenna panel one and another measurement may be reported for antenna panel two.

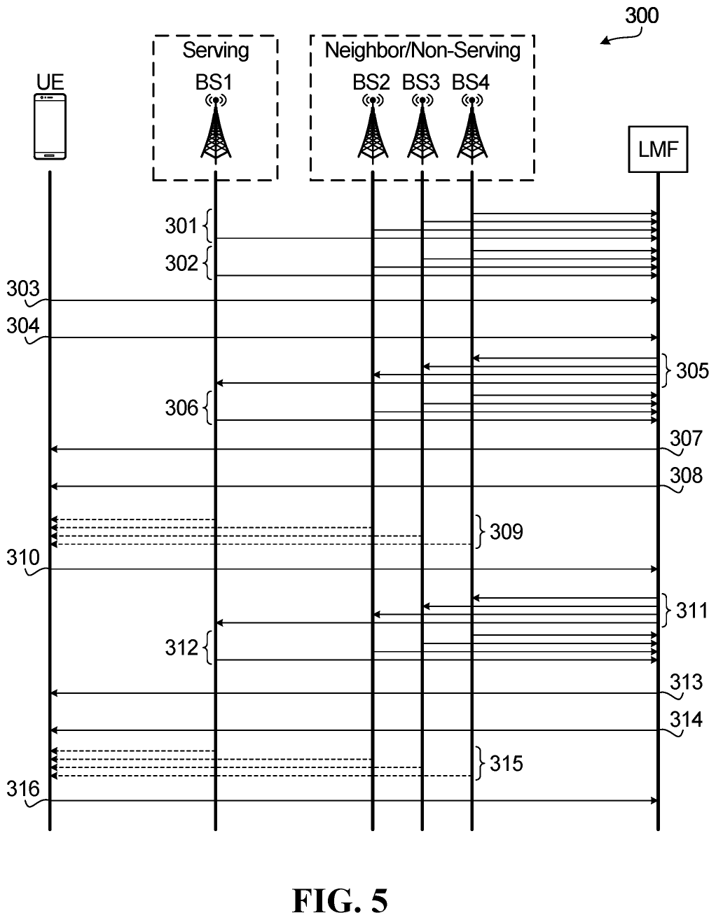

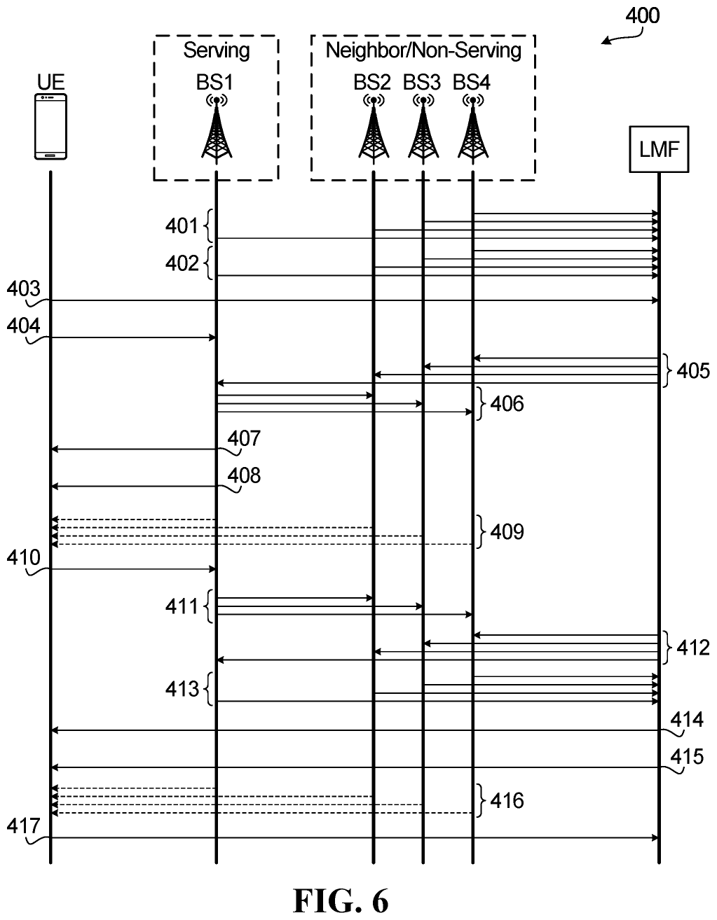

Examples of over the air information exchange procedures that may facilitate DL-based positioning according to the present disclosure will now be described with reference to FIGS. 5 and 6. It is to be understood that the example communication protocols mentioned in connection with the following example embodiments (e.g., radio resource control (RRC), LTE positioning protocol (LPP), and new radio positioning protocol annex (NR Positioning Protocol a, or NRPPa)) are merely examples of communication protocols that may be utilized in some embodiments and other protocols may be used in other embodiments now and/or in the future. For instance, RRC may be replaced by any other protocol that is terminated between a BS (e.g., gNB, which is a Next Generation NodeB (a node that provides NR user plane and control plane protocol terminations towards the UE)) and the target device (e.g., UE) to transport radio resource messages where the BS may itself be replaced by any node that is connected to the core network and provides user plane and control plane protocol terminations towards the target device. LPP may be replaced by any other protocol that is terminated between a target device and a positioning server (e.g., LMF). It may use either the control- or user-plane protocols as underlying transport. In turn, NRPPa may be replaced by any other protocol that carries information between a BS and a positioning server.

FIG. 5 is a signal flow diagram 300 of an example of an over the air information exchange procedure for DL-based positioning using DL positioning reference signals configured based on downlink channel measurements, in accordance with an embodiment of this disclosure.

In the signal flow diagram 300, a target device, a serving BS (BS1) for the target device, three neighbor or non-serving BSs (BS2-BS4) and a LMF are involved in an information exchange for DL-based positioning of the target device, which in this example is a UE. Although only one UE, one serving BS, three non-serving BSs, and one LMF are shown in FIG. 5 to avoid congestion in the drawing, data collection or information sharing during positioning, and similarly operation of a communication network, may involve any number of UEs, any number of serving and non-serving BSs and any number of LMFs. For example, in some embodiments positioning may be done with the joint efforts from multiple network devices and multiple UEs and positioning may be done on a per UE basis.

The information exchange procedure begins with the serving and non-serving BSs, BS1-BS4, sending DL PRS information to the LMF at 301. The DL PRS information sent by each BS indicates the DL PRS configurations that the BS is capable of supporting. In some embodiments, the DL PRS Information may include partial or full configurations of all PRSs that the BS can transmit to target devices for positioning measurements. The actually transmitted PRSs will be selected from the above pool of PRSs in later steps, as discussed in further detail below. In some embodiments, the DL PRS information may be sent to the LMF in response to receiving a request (not shown) from the LMF. In some embodiments, the DL PRS information may be transmitted to the LMF using the NRPPa protocol, for example.

At 302, each of the BSs, BS1-BS4, send DL RS information to the LMF. The DL RS information sent by each BS indicates the DL RS configurations that the BS is capable of supporting. In some embodiments, the DL RS information may include partial or full configuration of all DL RSs that the BS can potentially transmit to the UE for DL channel measurement. The actually transmitted RSs will be selected from the above pool of RSs in later steps, as discussed in further detail below. In some embodiments, the DL RS information may be sent to the LMF in response to receiving a request (not shown) from the LMF. In some embodiments, the DL RS information may be transmitted to the LMF using the NRPPa protocol, for example.

In some embodiments, the transmission of DL PRS information at 301 and the transmission of DL RS information at 302 are done in one step using a single message, e.g., via a single NRPPa message.

At 303, the UE signals its DL PRS processing capability and/or related measurement capability to the LMF by sending DL PRS capability information to the LMF. In some embodiments, the DL PRS capability information may be transmitted to the LMF using the LPP protocol, for example.

At 304, the UE signals its DL RS processing capability and/or related DL channel measurement capability to the LMF by sending DL RS capability information to the LMF. In some embodiments, the DL RSs that are selected for transmission to the target device are selected based in part on the DL RS capability information for the target device. In some embodiments, the DL RS capability information may be transmitted to the LMF using the LPP protocol, for example.

In some embodiments, the transmission of DL PRS capability information at 303 and the transmission of DL RS capability information at 304 are done in one step using a single message, e.g., via a single LPP message.

At step 305, the LMF sends a request to selected serving or non-serving BSs to provide configuration information for the DL RSs that will be transmitted to the UE for DL channel measurement. The request may include suggested values for some fields of the DL RS configurations based partly on the information provided by the UE and BSs in the previous steps and/or rough knowledge that the LMF has of the UE channel/location. For example, in some embodiments, a DL RS configuration may have many fields corresponding to different parameters that characterize a DL RS configuration (e.g., bandwidth, number of ports, QCL information, sequence ID, periodicity, offset, frequency hopping pattern, or precoder used, etc.). Some of these fields/parameters may be suggested by the LMF based on the knowledge acquired from the previous steps and/or the knowledge of the rough location of the UE. In some embodiments, the DL RS information request may be transmitted to the BSs using the NRPPa protocol, for example.

At step 306, each serving or non-serving BS sends a DL RS information response to the LMF in order to provide the LMF with the DL RS configuration information that was requested by the LMF at step 305. In some embodiments, a serving or non-serving BS may ignore values for the configuration fields that are suggested by LMF in the request for DL RS information. In other words, in some cases, the DL RS configuration information provided to the LMF by a BS at step 306 may include one or more configuration fields/parameters that differ from the configuration fields/parameters suggested by the LMF in the LMF's request for DL RS configuration information at step 305. In some embodiments, the DL RS information response may be transmitted to the LMF using the NRPPa protocol, for example.

At step 307, in order to assist the UE with receiving DL RS from the BSs, the LMF sends DL RS assistance data to the UE based on the DL RS information responses that the LMF received from the BSs at step 306. This allows the UE to know the configurations of the DL RS that it can expect to receive from the BSs for downlink channel measurements. In some embodiments, the DL RS assistance data may be transmitted to the UE using the LPP protocol, for example.

At step 308, the LMF sends a request to the UE to report DL channel measurements. In some embodiments, the request for DL channel measurements may identify a set of requested measurements. The set of requested measurements may be a subset of the examples of DL channel measurements that were discussed earlier, for example. In some embodiments, the request for DL RS measurement information may be transmitted to the UE using the LPP protocol, for example.

At step 309, each of the BSs transmits DL RS using the DL RS configuration the BS provided to LMF at step 306.

For its part, the UE, after receiving the request for DL RS measurement information at 308, searches for and carries out DL channel measurements on the DL RSs transmitted from the BSs at step 309.

At 310, the UE sends a DL RS measurement response to the LMF that includes the requested DL channel measurement information. In some embodiments, the DL channel measurement response containing the requested DL channel measurement information may be transmitted to the LMF using the LPP protocol, for example.

At 311, the LMF sends a request to selected serving or non-serving BSs to provide configuration information for the DL PRSs that will be transmitted to the UE for location measurement. The request may include suggested values for at least some fields of the DL PRS configurations based at least in part on the DL channel measurements received from the UE at 310. For example, in some embodiments, a DL PRS configuration may have many fields corresponding to different parameters that characterize a DL PRS configuration (e.g., bandwidth, number of ports, QCL information, sequence ID, periodicity, offset, frequency hopping pattern, precoder used, etc.). At least some of these fields/parameters may be suggested by the LMF based on the DL channel measurement information reported by the UE at 310. For instance, if the received DL RS SNR or RRSP is above a certain threshold, the same precoder and/or transmit beamformer that is used for DL RS is also used for DL PRS. In some cases only some of the fields/parameters may be determined based on the DL RS measurement results. In some cases, information in addition to the DL RS measurement results may be taken into account when determining a DL PRS configuration. For example, the LMF may have its own side information (such as UE capability, required measurement accuracy, required latency for positioning process) that may be taken into account when configuring DL PRS.

In some embodiments, the DL PRS information request may be transmitted to the BSs using the NRPPa protocol, for example.

At 312, each serving or non-serving BS sends a DL PRS information response to the LMF in order to provide the LMF with the DL RS configuration information that was requested by the LMF at step 311. In some embodiments, if a BS ignores a suggested value for a configuration field that was suggested by the LMF in the DL PRS configuration request and chooses a different value, the BS may provide the LMF with a reason for the change in the same response message that includes DL PRS configurations or in a separate message. For instance, the BS may not be able to transmit DL PRS with the bandwidth or periodicity and offset requested by LMF since the required time-frequency resources are not available due to, for instance, the BS serving other UEs for communication purposes in those time-frequency resources. In general, it may be preferable for the LMF to know the configuration of the DL PRS that is actually transmitted from a BS, because the LMF is the positioning coordinating node for all involved BSs. Moreover, it may be advantageous for the LMF to know why its recommended value for a specific DL PRS parameter is overridden by the BS so it could take into account the reason when recommending DL PRS configuration parameters in the next positioning session. In addition, it may be advantageous for the LMF to know the transmitted DL PRS configuration so it can assess the reliability of the positioning measurements that will be reported from the UE in later steps. For instance, if the transmitted DL PRS bandwidth is less than the value recommended by LMF, the resulting RSTD measurement may be less reliable. In some embodiments, the DL PRS information response may be transmitted to the LMF using the NRPPa protocol, for example.

At step 313, in order to assist the UE with receiving DL PRS from the BSs, the LMF sends DL PRS assistance data to the UE based on the DL PRS information responses that the LMF received from the BSs at step 312. The DL PRS assistance data includes information that allows the UE to know the configurations of the DL PRS that it can expect to receive from the BSs for positioning measurements. In some embodiments, the DL PRS assistance data may be transmitted to the UE using the LPP protocol, for example.

At step 314, the LMF sends a request to the UE to report location measurement information. In some embodiments, the request for location measurements may identify a set of requested measurements. The set of requested measurements may be a subset of the examples of location measurements that were discussed earlier, for example. In some embodiments, the request for location measurement information may be transmitted to the UE using the LPP protocol, for example.

At step 315, each of the BSs transmits DL PRS using the DL PRS configuration the BS provided to LMF at step 312.

For its part, the UE, after receiving the request for location measurement information at 314, searches for and carries out location measurements on the DL PRSs transmitted from the BSs at step 315. In some embodiments, the location measurements may include location-related measurements such as RSTD, DL-AoD, RSRP, UE Rx-Tx, Doppler measurement, ADR, carrier-phase measurement, code-phase measurement, a measurement quality indicator or measurement ambiguity range or measurement ambiguity indicator of any of the above location-related measurements, and, optionally, an actual estimated location of the UE.

At 316, the UE sends a location measurement response to the LMF that includes the requested location measurement information requested by the LMF at step 314. In some embodiments, the DL channel measurement response containing the requested location measurement information may be transmitted to the LMF using the LPP protocol, for example.

It should be noted that in some embodiments some of the above steps are optional and may be present only in some positioning sessions. For example, a target device may not need to signal its DL RS capability or DL PRS capability in every positioning session. As another example, the transmission of DL RS information at step 301 and/or the transmission of DL PRS information at step 302 may not be present in some embodiments.

Furthermore, in practice, the sequence of steps may not exactly follow the described sequence of steps. For example, the provision of DL PRS configuration information that is shown at step 313 may be done during the DL PRS transmission that is shown at step 315. As another example, the transmission of DL PRS capability information at step 303 or the transmission of DL RS capability information at step 304 may happen before the transmission of DL PRS information at step 301 or the transmission of DL RS information at step 302.

In some embodiments, the same message or information element (IE) may be used for carrying out two different steps of the procedure to the destination. For example, the DL RS information request of step 305 and the DL PRS information request of step 311 may use the same IE. As another example, the DL RS information response of step 306 and the DL PRS information response of step 312 may use the same IE or messages 313 and 314 from LMF to the UE may be provided in the same IE.

Potential technical benefit(s)/advantage(s) of the example embodiment shown in FIG. 5 include, but are not necessarily limited to, configuring PRS based partly on DL RS channel measurements. This allows PRS configuration based on the UE downlink channel, which may improve positioning performance (e.g., DL RS measurement report in step 310 that is used for DL PRS configuration can improve location measurement accuracy). Also, the LMF may use the original DL RS measurement results reported in Step 310 as side information when calculating UE's location from the DL PRS measurement results reported in step 316. Furthermore, in this example, the DL channel measurements reported to the LMF at step 310 may be reported using a point-to-point location protocol, such as LPP.

FIG. 6 is a signal flow diagram 400 of another example of an over the air information exchange procedure for DL-based positioning using DL positioning reference signals configured based on downlink channel measurements, in accordance with an embodiment of this disclosure. In contrast to the embodiment of FIG. 5, in the embodiment of FIG. 6 the DL RS of different BSs are configured through DL RS configuration information exchanged among BSs, whereas DL RS of different BSs are configured through a DL RS Information request/response process between BSs and the LMF in the embodiment of FIG. 5. This de-centralized configuration of DL RS in the embodiment of FIG. 6 potentially reduces latency due to less signalling between the BSs and the LMF.

In the signal flow diagram 400, a target device, a serving BS (BS1) for the target device, three neighbor or non-serving BSs (BS2-BS4) and a LMF are involved in an information exchange for DL-based positioning of the target device, which in this example is a UE. Similar to the previous example of FIG. 5, only one UE, one serving BS, three non-serving BSs, and one LMF are shown in FIG. 6 to avoid congestion in the drawing, but more generally data collection or information sharing during positioning, and similarly operation of a communication network, may involve any number of UEs, any number of serving and non-serving BSs and any number of LMFs.

The information exchange procedure 400 begins with the serving and non-serving BSs, BS1-BS4, sending DL PRS information to the LMF at 401. The DL PRS information sent by each BS indicates the DL PRS configurations that the BS is capable of supporting. In some embodiments, the DL PRS Information may include partial or full configurations of all PRSs that the BS can transmit to target devices for positioning measurements. The actually transmitted PRSs will be selected from the above pool of PRSs in later steps, as discussed in further detail below. In some embodiments, the DL PRS information may be sent to the LMF in response to receiving a request (not shown) from the LMF. In some embodiments, the DL PRS information may be transmitted to the LMF using the NRPPa protocol, for example.

At 402, each of the BSs, BS1-BS4, send DL RS information to the LMF. The DL RS information sent by each BS indicates the DL RS configurations that the BS is capable of supporting. In some embodiments, the DL RS information may include partial or full configuration of all DL RSs that the BS can potentially transmit to the UE for DL channel measurement. The actually transmitted RSs will be selected from the above pool of RSs in later steps, as discussed in further detail below. In some embodiments, the DL RS information may be sent to the LMF in response to receiving a request (not shown) from the LMF. In some embodiments, the DL RS information may be transmitted to the LMF using the NRPPa protocol, for example.

In some embodiments, the transmission of DL PRS information at 401 and the transmission of DL RS information at 402 are done in one step using a single message, e.g., via a single NRPPa message.

At 403, the UE signals its DL PRS processing capability and/or related measurement capability to the LMF by sending DL PRS capability information to the LMF. In some embodiments, the DL PRS capability information may be transmitted to the LMF using the LPP protocol, for example.

At 404, the UE signals its DL RS processing capability and/or related DL channel measurement capability to the serving BS by sending DL RS capability information to the serving BS. In some embodiments, the DL RSs that are selected for transmission to the target device are selected based in part on the DL RS capability information for the target device. In some embodiments, the DL RS capability information may be transmitted to the serving BS using the RRC protocol, for example.

At step 405, the LMF sends a DL RS activation request to selected serving or non-serving BSs to activate the DL RS that will be transmitted to the UE for downlink channel measurement. The request may include suggested values for some fields of the DL RS configurations based partly on the information provided by the UE and BSs in the previous steps and/or rough knowledge that the LMF has of the UE channel/location. For example, in some embodiments, a DL RS configuration may have many fields corresponding to different parameters that characterize a DL RS configuration (e.g., bandwidth, number of ports, QCL information, sequence ID, periodicity, offset, frequency hopping pattern, or precoder used, etc.). Some of these fields/parameters may be suggested by the LMF based on the knowledge acquired from the previous steps and/or the knowledge of the rough location of the UE. In some embodiments, the DL RS activation request may be transmitted to the BSs using the NRPPa protocol, for example.

At step 406, selected non-serving BSs send their DL RS configuration information to the serving BS. In some embodiments, the serving or non-serving BSs may ignore values for the configuration fields that are suggested by LMF in the request for DL RS activation at step 405. In other words, in some cases, the DL RS configuration selected by the serving BS and/or the DL RS configuration information provided to the serving BS by a non-serving BS at step 406 may include one or more configuration fields/parameters that differs from the configuration fields/parameters suggested by the LMF in the LMF's request for DL RS activation at step 405. In some embodiments, the serving BS may send a message (not shown) to a non-serving BS to request a re-configuration of DL RS or to change the values of some fields in the configured DL RS. In such embodiments, the non-serving BS receiving such message may provide the requested changes or may provide a reason for not complying with the serving BS's request. In some embodiments, messaging between BSs, including transmission of DL RS configuration information from the non-serving BSs to the serving BS may be done using the Xn protocol, for example.

At step 407, in order to assist the UE with receiving DL RS from the BSs, the serving BS sends the UE its own DL RS configuration information as well as the DL RS configuration information of the non-serving BSs that the serving BS received at step 406. This allows the UE to know the configurations of the DL RS that it can expect to receive from the BSs for downlink channel measurements. In some embodiments, the DL RS assistance information may be transmitted to the UE using the RRC protocol, for example.

At step 408, the serving BS sends a message to the UE to configure the UE to report DL channel measurements for the serving BS and the non-serving BSs. In some embodiments, the configuration message may configure the UE to perform a specific set of requested DL channel measurements. The set of requested DL channel measurements may be a subset of the examples of DL channel measurements that were discussed earlier, for example. In some embodiments, the configuration message may be transmitted to the UE using the RRC protocol, for example.

At step 409, each of the BSs transmits DL RS using the DL RS configuration the serving BS provided to UE at step 407.

For its part, the UE, in accordance with the configuration done at step 408, searches for and carries out DL channel measurements on the DL RSs transmitted from the BSs at step 409.

At 410, the UE sends a DL RS measurement response to the serving BS that includes the requested DL channel measurement information that was requested as part of the configuration at step 408. In some embodiments, the DL channel measurement response containing the requested DL channel measurement information may be transmitted to the serving BS using the RRC protocol, for example.

At 411, the serving BS transfers the DL channel measurements of each non-serving BS to the corresponding non-serving BS. In some embodiments, the transfer of the DL channel measurement information from the serving BS to the corresponding non-serving BSs may be done using the Xn protocol, for example.

At 412, the LMF sends a request to selected serving or non-serving BSs to provide configuration information for the DL PRSs that will be transmitted to the UE for location measurement. In some embodiments, the DL PRS information request may be transmitted to the BSs using the NRPPa protocol, for example.

At 413, each serving or non-serving BS sends a DL PRS information response to the LMF in order to provide the LMF with the DL RS configuration information that was requested by the LMF at step 412. The configuration of DL PRS at each BS is partly based on the received DL channel measurement report from the UE that was collected and transferred by the serving BS at steps 410 and 411. In some embodiments, the DL PRS information response may be transmitted to the LMF using the NRPPa protocol, for example.

At step 414, in order to assist the UE with receiving DL PRS from the BSs, the LMF sends DL PRS assistance data to the UE based on the DL PRS information responses that the LMF received from the BSs at step 413. The DL PRS assistance data includes information that allows the UE to know the configurations of the DL PRS that it can expect to receive from the BSs for positioning measurements. In some embodiments, the DL PRS assistance data may be transmitted to the UE using the LPP protocol, for example.

At step 415, the LMF sends a request to the UE to report location measurement information. In some embodiments, the request for location measurements may identify a set of requested measurements. The set of requested measurements may be a subset of the examples of location measurements that were discussed earlier, for example. In some embodiments, the request for location measurement information may be transmitted to the UE using the LPP protocol, for example.

At step 416, each of the BSs transmits DL PRS using the DL PRS configuration the BS provided to LMF at step 413.

For its part, the UE, after receiving the request for location measurement information at 415, searches for and carries out location measurements on the DL PRSs transmitted from the BSs at step 416. In some embodiments, the location measurements may include location-related measurements such as RSTD, DL-AoD, RSRP, UE Rx-Tx, Doppler measurement, ADR, carrier-phase measurement, code-phase measurement, a measurement quality indicator or measurement ambiguity range or measurement ambiguity indicator of any of the above location-related measurements, and, optionally, an actual estimated location of the UE.

At 417, the UE sends a location measurement response to the LMF that includes the requested location measurement information requested by the LMF at step 415. In some embodiments, the DL channel measurement response containing the requested location measurement information may be transmitted to the LMF using the LPP protocol, for example.

It should be noted that in some embodiments some of the above steps are optional and may be present only in some positioning sessions. For example, a target device may not need to signal its DL RS capability or DL PRS capability in every positioning session. As another example, the transmission of DL RS information at step 401 and/or the transmission of DL PRS information at step 402 may not be present in some embodiments.

Furthermore, in practice, the sequence of steps may not exactly follow the described sequence of steps. For example, the provision of DL PRS configuration information that is shown at step 414 may be done during the DL PRS transmission that is shown at step 416. As another example, the transmission of DL channel measurement configuration information shown at step 408 may happen before the transmission of DL RS configuration information shown at step 407.

In some embodiments, the same message or information element (IE) may be used for carrying out two different steps of the procedure to the destination. For example, the DL RS activation request of step 405 and the DL PRS information request of step 412 may use the same IE or messages 414 and 415 from LMF to the UE may be provided in the same IE.

Potential technical benefit(s)/advantage(s) of the example embodiment shown in FIG. 6 include, but are not necessarily limited to, configuring PRS based partly on DL RS channel measurements. This allows PRS configuration based on the UE downlink channel, which may improve positioning performance (e.g., DL RS measurement report in step 410 that is used for DL PRS configuration can improve location measurement accuracy). Moreover, since DL RS measurement results are reported to BSs instead of the LMF (which is located in core network), the latency of the whole positioning procedure may be reduced compared to the procedure described in FIG. 5. Furthermore, in this example, the DL channel measurements may be reported to the BSs using Physical (PHY) layer signaling between the UE and the serving BS and Xn signaling between the serving BS and the non-serving BSs.

Differences between the embodiment of FIGS. 5 and 6 are as follows:
1. UL DL RS capability transfer is provided to the LMF in the embodiment of FIG. 5, whereas it is provided to the serving BS in the embodiment of FIG. 6.
2. There is no DL RS activation command in the embodiment of FIG. 5.
3. DL RS of different BSs are configured through DL RS configuration information exchange among BSs in step 406 of the embodiment of FIG. 6, whereas DL RS of different BSs are configured through a DL RS Information request/response process between BSs and the LMF in steps 305 and 306 of the embodiment of FIG. 5. This explains one main difference between the procedure described in FIG. 5 and FIG. 6: LMF has a more central control on the configuration of all DL RSs in FIG. 5. This may result in an optimized DL RSs configurations and, consequently, a better positioning performance. Similar to the procedure described in FIG. 5, DL PRS configurations in FIG. 6 are in part based on the DL RS measurement reports to the network. This, as explained before, improves the positioning performance. Further, as discussed above, since DL RS measurement results are reported to BSs instead of the LMF (which is located in core network), the latency of the whole positioning procedure is reduced compared to the procedure described in FIG. 5.
4. DL RS configurations and the required measurements are provided to the UE from the LMF in steps 307 and 308 of the embodiment of FIG. 5, whereas DL RS configurations and the required measurements are provided to the UE from the serving BS in steps 407 and 408 of the embodiment of FIG. 6.
5. The DL RS measurement response (DL channel measurement reports) is transmitted from the UE to the LMF in the embodiment of FIG. 5, whereas DL RS measurement reports are transmitted from the UE to the serving BS and then from the serving BS to the non-serving BSs in the embodiment of FIG. 6.

The following provides a non-limiting list of additional Example Embodiments of the present disclosure:

Example Embodiment 1. A method for positioning in a wireless communication network, the method comprising: receiving, by a target device, a downlink (DL) reference signal (RS) from a base station (BS) in the wireless communication network; transmitting, by the target device, DL channel measurement information regarding one or more DL channel measurements obtained by the target device based on the received DL RS; receiving, by the target device from the BS, a DL positioning reference signal (PRS) configured based at least in part on the DL channel measurement information; and transmitting, by the target device, positioning measurement information regarding one or more location measurements obtained by the target device based on the received DL PRS.

Example Embodiment 2. The method of Example Embodiment 1, wherein the BS is a non-serving BS for the target device.

Example Embodiment 3. The method of Example Embodiment 1, wherein: receiving a DL RS from a BS in the wireless communication network comprises receiving, from each of a plurality of BSs in the wireless communication network, a respective DL RS, the plurality of BSs including a serving BS and one or more non-serving BS for the target device; transmitting DL channel measurement information comprises transmitting DL channel measurement information that comprises, for each BS of the plurality of BSs, respective DL channel measurement information regarding one or more DL channel measurements based on the respective DL RS received from the corresponding BS; and receiving a DL PRS from the BS comprises receiving, from each of the plurality of BSs, a respective DL PRS, each respective DL PRS being configured based in part on the respective DL channel measurement information for the corresponding BS.

Example Embodiment 4. The method of Example Embodiment 1, further comprising receiving, by the target device, DL RS assistance data for use in assisting the target device to receive the DL RS.

Example Embodiment 5. The method of Example Embodiment 4, wherein the DL RS assistance data is received by the target device via a Long Term Evolution Positioning Protocol (LPP) message from a Location Management Function (LMF) in the wireless communication network.

Example Embodiment 6. The method of Example Embodiment 1, further comprising receiving, by the target device from a Location Management Function (LMF) in the wireless communication network, a request for DL channel measurement information, wherein, after receiving the request for DL channel measurement information, the target device in accordance with the request: receives the DL RS; performs the one or more DL channel measurements; and transmits the DL channel measurement information in response to the request.

Example Embodiment 7. The method of Example Embodiment 6, wherein the request for DL channel measurement information is received by the target device via a Long Term Evolution Positioning Protocol (LPP) message from the LMF, and the DL channel measurement information is transmitted to the LMF via a LPP message from the target device.

Example Embodiment 8. The method of Example Embodiment 1, further comprising transmitting, by the target device, DL RS capability information regarding DL RS processing capability and/or related DL channel measurement capability for the target device.

Example Embodiment 9. The method of Example Embodiment 1, wherein receiving a DL RS from a BS in the wireless communication network comprises receiving, from each of a plurality of BSs in the wireless communication network, a respective DL RS, the plurality of BSs including a serving BS and one or more non-serving BS for the target device, the method further comprising receiving, by the target device via a radio resource control (RRC) message from the serving base station, DL RS configuration information for use in assisting the target device to receive the respective DL RSs from the plurality of BSs.

Example Embodiment 10. The method of Example Embodiment 1, wherein receiving a DL RS from a BS in the wireless communication network comprises receiving, from each of a plurality of BSs in the wireless communication network, a respective DL RS, the plurality of BSs including a serving BS and one or more non-serving BS for the target device, the method further comprising receiving, by the target device from the serving base station, DL measurement configuration information, wherein, after receiving the DL measurement configuration information, the target device in accordance with the request: receives the respective DL RS from each BS; performs, for each BS of the plurality of BSs, the one or more DL channel measurements based on the respective DL RS received from the corresponding BS; and transmits the DL channel measurement information that comprises, for each BS of the plurality of BSs, the respective DL channel measurement information based on the one or more DL channel measurements for the corresponding BS.

Example Embodiment 11. The method of Example Embodiment 10, wherein the target device transmits the DL channel measurement information to the serving base station.

Example Embodiment 12. A method for downlink positioning in a wireless communication network, the method comprising: transmitting, by a base station (BS), a downlink (DL) reference signal (RS) to a target device in the wireless communication network; and transmitting, by the BS, a DL positioning reference signal (PRS) to the target device, the DL PRS being configured based in part on DL channel measurement information reported by the target device based on the received DL RS at the target device.

Example Embodiment 13. The method of Example Embodiment 12, wherein the BS is a non-serving BS for the target device.

Example Embodiment 14. The method of Example Embodiment 12, wherein the BS is a serving BS for the target device.

Example Embodiment 15. The method of Example Embodiment 12, further comprising: transmitting, by the BS, DL RS capability information to a location management function (LMF) in the wireless communication network, the DL RS capability information indicating DL RS configurations the BS is capable of transmitting for DL channel measurement.

Example Embodiment 16. The method of Example Embodiment 15, further comprising, before transmitting the DL RS to the target device: receiving, by the BS from the LMF, a DL RS information request for the BS to provide DL RS configuration information regarding configuration of the DL RS that will be transmitted to the target device for DL channel measurement.

Example Embodiment 17. The method of Example Embodiment 16, wherein the DL RS information request comprises information regarding at least a partial suggested configuration for the DL RS that will be transmitted to the target device.

Example Embodiment 18. The method of Example Embodiment 16, further comprising: transmitting, by the BS to the LMF, a DL RS information response to the DL RS information request, the DL RS information response containing the requested DL RS configuration information for the DL RS that will be transmitted to the target device for DL channel measurement.

Example Embodiment 19. The method of Example Embodiment 18, wherein the DL RS transmitted by the BS to the target device is configured in accordance with the DL RS configuration information transmitted to the LMF in the DL RS information response.

Example Embodiment 20. The method of Example Embodiment 12, further comprising, before transmitting the DL RS to the target device: receiving, by the BS from the LMF, a DL RS activation request for the BS to transmit the DL RS to the target device for DL channel measurement.

Example Embodiment 21. The method of Example Embodiment 20, wherein the DL RS activation request comprises information regarding at least a partial suggested configuration for the DL RS that will be transmitted to the target device.

Example Embodiment 22. The method of Example Embodiment 13, further comprising: transmitting, from the non-serving base station to a serving base station for the target device, DL RS configuration information for the DL RS that the non-serving base station is configured to transmit to the target device for DL channel measurement.

Example Embodiment 23. The method of Example Embodiment 14, further comprising: receiving, by the serving base station from each of one or more non-serving base stations for the target device, respective DL RS configuration information for the respective DL RS that each non-serving base station is configured to transmit to the target device for DL channel measurement.

Example Embodiment 24. The method of Example Embodiment 23, further comprising, before transmitting the DL RS to the target device: transmitting, by the serving base station to the target device, DL RS configuration information for the DL RS the serving base station is configured to transmit to the target device, and respective DL RS configuration information for the respective DL RS each of the one or more non-serving base stations is configured to transmit to the target device.

Example Embodiment 25. The method of Example Embodiment 24, further comprising, before transmitting the DL RS to the target device: transmitting, by the serving base station to the target device, DL measurement configuration information to configure the target device to report DL channel measurement information for the serving base station and the one or more non-serving base stations based on the DL RS transmitted by the serving base station and the respective DL RS transmitted by each of the one or more non-serving base stations.

Example Embodiment 26. The method of Example Embodiment 25, further comprising: receiving, by the serving base station from the target device, a report of the DL channel measurement information for the serving base station and the one or more non-serving base stations.

Example Embodiment 27. The method of Example Embodiment 26, further comprising, before transmitting the DL PRS to the target device: transmitting, by the serving base station to a location management function (LMF) in the wireless communication network, DL PRS configuration information for the DL PRS the serving base station is configured to transmit to the target device based in part on the DL channel measurement information reported by the target device for the serving base station.

Example Embodiment 28. The method of Example Embodiment 26, further comprising: for each of the one or more non-serving base stations, transmitting, by the serving base station to the non-serving base station, the respective DL channel measurement information reported by the target device for the non-serving base station.

Example Embodiment 29. The method of Example Embodiment 22, further comprising: receiving, by the non-serving base station from the serving base station, respective DL channel measurement information reported by the target device based on the respective DL RS transmitted by the non-serving base station to the target device.

Example Embodiment 30. The method of Example Embodiment 29, further comprising, before transmitting the DL PRS to the target device: transmitting, by the non-serving base station to a location management function (LMF) in the wireless communication network, DL PRS configuration information for the DL PRS the non-serving base station is configured to transmit to the target device based in part on the DL channel measurement information reported by the target device for the non-serving base station.

Example Embodiment 31. An apparatus comprising: at least one processor; and a computer readable storage medium operatively coupled to the at least one processor, the computer readable storage medium storing programming for execution by the at least one processor, the programming comprising instructions for: receiving, by the apparatus, a downlink (DL) reference signal (RS) from a base station (BS) in a wireless communication network; transmitting, by the apparatus, DL channel measurement information regarding one or more DL channel measurements obtained by the apparatus based on the received DL RS; receiving, by the apparatus from the BS, a DL positioning reference signal (PRS) configured based at least in part on the DL channel measurement information; transmitting, by the apparatus, positioning measurement information regarding one or more location measurements obtained by the apparatus based on the received DL PRS.

Example Embodiment 32. The apparatus of Example Embodiment 31, wherein the BS is a non-serving BS for the apparatus.

Example Embodiment 33. The apparatus of Example Embodiment 31, wherein: receiving a DL RS from a BS in the wireless communication network comprises receiving, from each of a plurality of BSs in the wireless communication network, a respective DL RS, the plurality of BSs including a serving BS and one or more non-serving BS for the apparatus; transmitting DL channel measurement information comprises transmitting DL channel measurement information that comprises, for each BS of the plurality of BSs, respective DL channel measurement information regarding one or more DL channel measurements based on the respective DL RS received from the corresponding BS; and receiving a DL PRS from the BS comprises receiving, from each of the plurality of BSs, a respective DL PRS, each respective DL PRS being configured based in part on the respective DL channel measurement information for the corresponding BS.

Example Embodiment 34. The apparatus of Example Embodiment 31, wherein the programming comprises instructions for receiving, by the apparatus, DL RS assistance data for use in assisting the apparatus to receive the DL RS.

Example Embodiment 35. The apparatus of Example Embodiment 34, wherein the DL RS assistance data is received by the apparatus via a Long Term Evolution Positioning Protocol (LPP) message from a Location Management Function (LMF) in the wireless communication network.

Example Embodiment 36. The apparatus of Example Embodiment 31, wherein the programming comprises instructions for receiving, by the apparatus from a Location Management Function (LMF) in the wireless communication network, a request for DL channel measurement information, wherein, after receiving the request for DL channel measurement information, the apparatus in accordance with the request: receives the DL RS; performs the one or more DL channel measurements; and transmits the DL channel measurement information in response to the request.

Example Embodiment 37. The apparatus of Example Embodiment 36, wherein the request for DL channel measurement information is received by the apparatus via a Long Term Evolution Positioning Protocol (LPP) message from the LMF, and the DL channel measurement information is transmitted to the LMF via a LPP message from the apparatus.

Example Embodiment 38. The apparatus of Example Embodiment 31, wherein the programming comprises instructions for transmitting, by the apparatus, DL RS capability information regarding DL RS processing capability and/or related DL channel measurement capability for the apparatus.

Example Embodiment 39. The apparatus of Example Embodiment 31, wherein receiving a DL RS from a BS in the wireless communication network comprises receiving, from each of a plurality of BSs in the wireless communication network, a respective DL RS, the plurality of BSs including a serving BS and one or more non-serving BS for the apparatus, the method further comprising receiving, by the apparatus via a radio resource control (RRC) message from the serving base station, DL RS configuration information for use in assisting the apparatus to receive the respective DL RSs from the plurality of BSs.

Example Embodiment 40. The apparatus of Example Embodiment 41, wherein receiving a DL RS from a BS in the wireless communication network comprises receiving, from each of a plurality of BSs in the wireless communication network, a respective DL RS, the plurality of BSs including a serving BS and one or more non-serving BS for the apparatus, the method further comprising receiving, by the apparatus from the serving base station, DL measurement configuration information, wherein, after receiving the DL measurement configuration information, the apparatus in accordance with the request: receives the respective DL RS from each BS; performs, for each BS of the plurality of BSs, the one or more DL channel measurements based on the respective DL RS received from the corresponding BS; and transmits the DL channel measurement information that comprises, for each BS of the plurality of BSs, the respective DL channel measurement information based on the one or more DL channel measurements for the corresponding BS.

Example Embodiment 41. The apparatus of Example Embodiment 40, wherein the apparatus transmits the DL channel measurement information to the serving base station.

Example Embodiment 42. An apparatus comprising: at least one processor; and a computer readable storage medium operatively coupled to the at least one processor, the computer readable storage medium storing programming for execution by the at least one processor, the programming comprising instructions for: transmitting, by the apparatus, a downlink (DL) reference signal (RS) to a target device in the wireless communication network; and transmitting, by the apparatus, a DL positioning reference signal (PRS) to the target device, the DL PRS being configured based in part on DL channel measurement information reported by the target device based on the received DL RS at the target device.

Example Embodiment 43. The apparatus of Example Embodiment 42, wherein the apparatus is a non-serving BS for the target device.

Example Embodiment 44. The apparatus of Example Embodiment 42, wherein the apparatus is a serving BS for the target device.

Example Embodiment 45. The apparatus of Example Embodiment 42, wherein the programming comprises instructions for: transmitting, by the apparatus, DL RS capability information to a location management function (LMF) in the wireless communication network, the DL RS capability information indicating DL RS configurations the apparatus is capable of transmitting for DL channel measurement.

Example Embodiment 46. The apparatus of Example Embodiment 45, wherein the programming comprises instructions for: before transmitting the DL RS to the target device, receiving, by the apparatus from the LMF, a DL RS information request for the apparatus to provide DL RS configuration information regarding configuration of the DL RS that will be transmitted to the target device for DL channel measurement.

Example Embodiment 47. The apparatus of Example Embodiment 46, wherein the DL RS information request comprises information regarding at least a partial suggested configuration for the DL RS that will be transmitted to the target device.

Example Embodiment 48. The apparatus of Example Embodiment 46, wherein the programming comprises instructions for: transmitting, by the apparatus to the LMF, a DL RS information response to the DL RS information request, the DL RS information response containing the requested DL RS configuration information for the DL RS that will be transmitted to the target device for DL channel measurement.

Example Embodiment 49. The apparatus of Example Embodiment 48, wherein the DL RS transmitted by the apparatus to the target device is configured in accordance with the DL RS configuration information transmitted to the LMF in the DL RS information response.

Example Embodiment 50. The apparatus of Example Embodiment 42, wherein the programming comprises instructions for: before transmitting the DL RS to the target device, receiving, by the apparatus from the LMF, a DL RS activation request for the apparatus to transmit the DL RS to the target device for DL channel measurement.

Example Embodiment 51. The apparatus of Example Embodiment 50, wherein the DL RS activation request comprises information regarding at least a partial suggested configuration for the DL RS that will be transmitted to the target device.

Example Embodiment 52. The apparatus of Example Embodiment 43, wherein the programming comprises instructions for: transmitting, from the apparatus to a serving base station for the target device, DL RS configuration information for the DL RS that the apparatus is configured to transmit to the target device for DL channel measurement.

Example Embodiment 53. The apparatus of Example Embodiment 44, wherein the programming comprises instructions for: receiving, by the apparatus from each of one or more non-serving base stations for the target device, respective DL RS configuration information for the respective DL RS that each non-serving base station is configured to transmit to the target device for DL channel measurement.

Example Embodiment 54. The apparatus of Example Embodiment 53, wherein the programming comprises instructions for: before transmitting the DL RS to the target device, transmitting, by the apparatus to the target device, DL RS configuration information for the DL RS the apparatus is configured to transmit to the target device, and respective DL RS configuration information for the respective DL RS each of the one or more non-serving base stations is configured to transmit to the target device.

Example Embodiment 55. The apparatus of Example Embodiment 54, wherein the programming comprises instructions for: before transmitting the DL RS to the target device, transmitting, by the apparatus to the target device, DL measurement configuration information to configure the target device to report DL channel measurement information for the apparatus and the one or more non-serving base stations based on the DL RS transmitted by the apparatus and the respective DL RS transmitted by each of the one or more non-serving base stations.

Example Embodiment 56. The apparatus of Example Embodiment 55, wherein the programming comprises instructions for: receiving, by the apparatus from the target device, a report of the DL channel measurement information for the apparatus and the one or more non-serving base stations.

Example Embodiment 57. The apparatus of Example Embodiment 56, wherein the programming comprises instructions for: before transmitting the DL PRS to the target device, transmitting, by the apparatus to a location management function (LMF) in the wireless communication network, DL PRS configuration information for the DL PRS the apparatus is configured to transmit to the target device based in part on the DL channel measurement information reported by the target device for the apparatus.

Example Embodiment 58. The apparatus of Example Embodiment 56, wherein the programming comprises instructions for: for each of the one or more non-serving base stations, transmitting, by the apparatus to the non-serving base station, the respective DL channel measurement information reported by the target device for the non-serving base station.

Example Embodiment 59. The apparatus of Example Embodiment 52, wherein the programming comprises instructions for: receiving, by the apparatus from the serving base station, respective DL channel measurement information reported by the target device based on the respective DL RS transmitted by the apparatus to the target device.

Example Embodiment 60. The apparatus of Example Embodiment 59, wherein the programming comprises instructions for: before transmitting the DL PRS to the target device, transmitting, by the apparatus to a location management function (LMF) in the wireless communication network, DL PRS configuration information for the DL PRS the apparatus is configured to transmit to the target device based in part on the DL channel measurement information reported by the target device for the apparatus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

What is claimed is:

1. A method for positioning in a wireless communication network, the method comprising:
receiving, by an apparatus, a downlink (DL) reference signal (RS) from a base station (BS) in the wireless communication network;
transmitting, by the apparatus, DL channel measurement information regarding one or more DL channel measurements obtained by the apparatus based on the received DL RS;
receiving, by the apparatus from the BS, a DL positioning reference signal (PRS) configured based at least in part on the DL channel measurement information;
transmitting, by the apparatus, positioning measurement information regarding one or more location measurements obtained by the apparatus based on the received DL PRS.

2. The method of claim 1, wherein the BS is a non-serving BS for the apparatus.

3. The method of claim 1, further comprising receiving, by the apparatus, DL RS assistance data for use in assisting the apparatus to receive the DL RS, wherein the DL RS assistance data is received by the apparatus via a Long Term Evolution Positioning Protocol (LPP) message from a Location Management Function (LMF) in the wireless communication network.

4. The method of claim 1, further comprising receiving, by the apparatus from a Location Management Function (LMF) in the wireless communication network, a request for DL channel measurement information, wherein, after receiving the request for DL channel measurement information, the apparatus in accordance with the request:
receives the DL RS;
performs the one or more DL channel measurements; and
transmits the DL channel measurement information in response to the request.

5. The method of claim 4, wherein the request for DL channel measurement information is received by the apparatus via a Long Term Evolution Positioning Protocol (LPP) message from the LMF, and the DL channel measurement information is transmitted to the LMF via a LPP message from the apparatus.

6. A method for downlink positioning in a wireless communication network, the method comprising:
transmitting, by a base station (BS), a downlink (DL) reference signal (RS) to an apparatus in the wireless communication network; and
transmitting, by the BS, a DL positioning reference signal (PRS) to the apparatus, the DL PRS being configured based in part on DL channel measurement information reported by the apparatus based on the received DL RS at the apparatus.

7. The method of claim 6, wherein the BS is a non-serving BS for the apparatus.

8. The method of claim 6, further comprising:
transmitting, by the BS, DL RS capability information to a location management function (LMF) in the wireless communication network, the DL RS capability information indicating DL RS configurations the BS is capable of transmitting for DL channel measurement.

9. The method of claim 8, further comprising, before transmitting the DL RS to the apparatus:
receiving, by the BS from the LMF, a DL RS information request for the BS to provide DL RS configuration information regarding configuration of the DL RS that will be transmitted to the apparatus for DL channel measurement.

10. The method of claim 9, further comprising:
transmitting, by the BS to the LMF, a DL RS information response to the DL RS information request, the DL RS information response containing the requested DL RS configuration information for the DL RS that will be transmitted to the apparatus for DL channel measurement.

11. The method of claim 6, further comprising, before transmitting the DL RS to the apparatus:
receiving, by the BS from the LMF, a DL RS activation request for the BS to transmit the DL RS to the apparatus for DL channel measurement.

12. The method of claim 7, further comprising:
transmitting, from the non-serving base station to a serving base station for the apparatus, DL RS configuration information for the DL RS that the non-serving base station is configured to transmit to the apparatus for DL channel measurement.

13. The method of claim 12, further comprising:
receiving, by the non-serving base station from the serving base station, respective DL channel measurement information reported by the apparatus based on the respective DL RS transmitted by the non-serving base station to the apparatus.

14. The method of claim 13, further comprising, before transmitting the DL PRS to the apparatus:
transmitting, by the non-serving base station to a location management function (LMF) in the wireless communication network, DL PRS configuration information for the DL PRS the non-serving base station is configured to transmit to the apparatus based in part on the DL channel measurement information reported by the apparatus for the non-serving base station.

15. An apparatus comprising:
at least one processor; and
a computer readable storage medium operatively coupled to the at least one processor, the computer readable storage medium storing programming for execution by the at least one processor, the programming comprising instructions for:
receiving, by the apparatus, a downlink (DL) reference signal (RS) from a base station (BS) in a wireless communication network;
transmitting, by the apparatus, DL channel measurement information regarding one or more DL channel measurements obtained by the apparatus based on the received DL RS;
receiving, by the apparatus from the BS, a DL positioning reference signal (PRS) configured based at least in part on the DL channel measurement information;
transmitting, by the apparatus, positioning measurement information regarding one or more location measurements obtained by the apparatus based on the received DL PRS.

16. The apparatus of claim 15, wherein the BS is a non-serving BS for the apparatus.

17. The apparatus of claim 15, wherein the programming comprises instructions for receiving, by the apparatus, DL RS assistance data for use in assisting the apparatus to receive the DL RS, wherein the DL RS assistance data is received by the apparatus via a Long Term Evolution Positioning Protocol (LPP) message from a Location Management Function (LMF) in the wireless communication network.

18. The apparatus of claim 15, wherein the programming comprises instructions for receiving, by the apparatus from a Location Management Function (LMF) in the wireless communication network, a request for DL channel measurement information, wherein, after receiving the request for DL channel measurement information, the apparatus in accordance with the request:
receives the DL RS;
performs the one or more DL channel measurements; and
transmits the DL channel measurement information in response to the request.

19. A base station comprising:
at least one processor; and
a computer readable storage medium operatively coupled to the at least one processor, the computer readable storage medium storing programming for execution by the at least one processor, the programming comprising instructions for:
transmitting a downlink (DL) reference signal (RS) to an apparatus in the wireless communication network; and
transmitting a DL positioning reference signal (PRS) to the apparatus, the DL PRS being configured based in part on DL channel measurement information reported by the apparatus based on the received DL RS at the apparatus.

20. The base station of claim 19, wherein the base station is a non-serving base station for the apparatus.

21. The base station of claim 19, wherein the programming comprises instructions for:
transmitting DL RS capability information to a location management function (LMF) in the wireless communication network, the DL RS capability information indicating DL RS configurations the base station is capable of transmitting for DL channel measurement.

22. The base station of claim 21, wherein the programming comprises instructions for:
before transmitting the DL RS to the apparatus, receiving from the LMF, a DL RS information request for the base station to provide DL RS configuration information regarding configuration of the DL RS that will be transmitted to the apparatus for DL channel measurement.

23. The base station of claim 22, wherein the programming comprises instructions for:
transmitting to the LMF, a DL RS information response to the DL RS information request, the DL RS information response containing the requested DL RS configuration information for the DL RS that will be transmitted to the apparatus for DL channel measurement.

24. The base station of claim 20, wherein the programming comprises instructions for:
transmitting to a serving base station for the apparatus, DL RS configuration information for the DL RS that the base station is configured to transmit to the apparatus for DL channel measurement.
